(19) United States
(12) Patent Application Publication
(10) Pub. No.: US 2006/0227183 A1
(43) Pub. Date: Oct. 12, 2006

(54) Ink jet recording apparatus and method

(75) Inventors: Takaichiro Umeda, Nagoya-shi (JP); Hiroaki Yazawa, Nagoya-shi (JP); Hisaki Sakurai, Aichi-ken (JP); Hikaru Kaga, Aisai-shi (JP)

Correspondence Address: BANNER & WITCOFF, LTD.;ATTORNEYS FOR CLIENT NOS. 0166889, 006760, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/385,930

(22) Filed: Mar. 22, 2006

(30) Foreign Application Priority Data
Mar. 22, 2005 (JP) 2005-081845

(51) Int. Cl. B41J 2/175

(52) U.S. Cl. 347/85

(57) ABSTRACT

An ink jet recording apparatus with color reproducibility is described. A printer including an ink jet recording apparatus according to one or more aspects of the invention has ink tanks for storing basic color inks and sub-tanks. The basic color inks can be supplied to basic color sub-tanks by a pressurizing pump. The basic color sub-tanks can be connected to mixed color sub-tanks. The sub-tanks can have open/closed switch valves for allowing the inflow of ink. In at least one aspect, the ink tanks and the basic color sub-tanks may be connected by connecting pipes.

This application claims priority to Japanese Patent Application No. 2005-081845, filed Mar. 22, 2005, whose contents are expressly incorporated herein by reference.

### BACKGROUND

1. Field of the Invention

Aspects of the invention relate to an ink jet recording apparatus for performing image-recording by discharging ink droplets onto a recording medium.

2. Description of Related Art

In an image-recording apparatus discharging ink droplets (normally called an ‘ink jet recording apparatus’), inks of different colors such as yellow, cyan, magenta and black are supplied to a recording head. By a predetermined method, the recording head discharges the different colors of ink to form dots on a recording medium, thereby forming a color image on the recording medium. One efficient aspect of an ink jet recording apparatus is what is called its ‘color reproducibility’. Color reproducibility is a criterion of the size of the difference between the coloring of the original and the coloring of the image formed onto a recording medium. The better its color reproducibility is (the smaller the difference in coloring is) the closer the coloring of an image formed by the ink jet recording apparatus will be to the coloring of the actual subject.

If the number of different colors of inks discharged onto the recording medium is large (that is, if inks of many colors contribute to the image-recording), the color reproducibility of any color improves. Because of this, among ink jet recording apparatuses of ink jet related art, there are those in which many ink cartridges are mounted and many inks are pre-stocked.

In the ink jet recording apparatus in which many ink cartridges are mounted independently, an ink of every color has to be stocked irrespective of the frequencies of use of the different colors. Consequently, there is the problem that the running cost of the ink jet recording apparatus increases. In a related art, to avoid this problem, an ink jet recording apparatus has been proposed wherein inks of predetermined colors are prepared by mixing in advance and these are poured into ink cartridges. However, because this kind of ink preparation technique of related art is constructed as a device provided separately for mixing ink, there has been the problem that the ink jet recording apparatus becomes large and its manufacturing cost greatly increases.

### SUMMARY

Aspects of the invention relate to an ink jet printing system that addresses one or more issues of the related art, thereby providing an improved recording system.

### BRIEF DESCRIPTION OF THE DRAWINGS

FIG. 1 is an external perspective view of a multi-function device pertaining to an embodiment of the invention.

FIG. 2 is a schematic view showing the construction of a printer part of a multi-function device pertaining to an embodiment of the invention.

FIG. 3 is a perspective view showing schematically an image-recording part of a multi-function device pertaining to an embodiment of the invention.

FIG. 4 is a block diagram showing schematically the construction of an image-recording part of a multi-function device pertaining to an embodiment of the invention.

FIG. 5 is an enlarged bottom view of a recording head of a multi-function device pertaining to an embodiment of the invention.

FIG. 6 is a sectional view of a head part of a multi-function device pertaining to an embodiment of the invention.

FIG. 7 is a block diagram showing the construction of a control unit of a multi-function device pertaining to an embodiment of the invention.

FIG. 8 is a view showing schematically an ink supply path and operating positions of a recording head in a multi-function device pertaining to an embodiment of the invention.

FIGS. 9A-9B are flow charts showing how basic color inks are supplied to basic color sub-tanks.

FIGS. 10A-10B are a flow charts showing how a mixed color ink is created by two basic color inks being mixed.

FIGS. 11A-11B are flow charts showing how a mixed color ink is created by three basic color inks being mixed.

### DETAILED DESCRIPTION

It is noted that various connections are set forth between elements in the following description. It is noted that these connections in general and, unless specified otherwise, may be direct or indirect and that this specification is not intended to be limiting in this respect.

General Overview

In at least one aspect of the present invention, an ink jet recording apparatus may include basic color ink tanks and sub tanks. Ink from the basic color ink tanks may be supplied to the sub tanks, individually or in combination. The combined colors may be used with the basic colors for printing.

The basic color sub-tanks and the mixed color sub-tanks may or may not be held in a scanning carriage together with a recording head. The ink tanks may or may not be connected to the basic color sub-tanks by flexible tubes that allow relative movement of the basic color sub-tanks with respect to the ink tanks.

The pressurizing supply system may or may not include a pressurizing pump for creating an ink supply pressure to be applied to the ink tanks. It may or may not also include supply pressure switching unit, interposed between the pressurizing pump and the ink tanks, for applying the ink supply pressure to any of the ink tanks.

The supply pressure switching unit may or may not include a multi-way electromagnetic valve having an input port connected to the pressurizing pump and n output ports each connected individually to a respective one of the ink tanks.

The opening/closing valves may or may not be made up of opening/closing switch valves for releasing pressures arising in the ink tanks, basic color sub-tanks and mixed color sub-tanks.

### Embodiments

Aspects of the invention are described below.

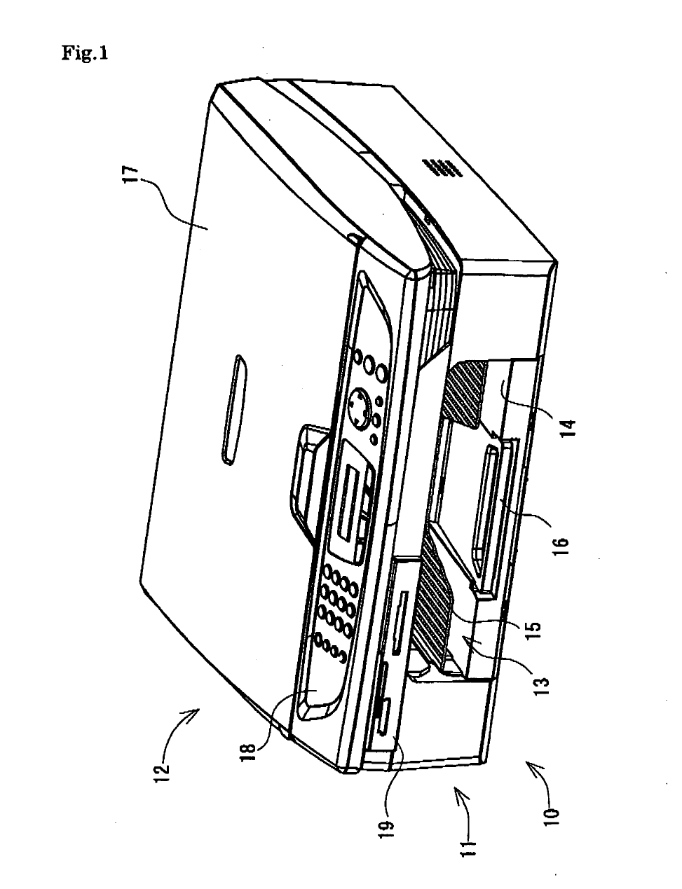

FIG. 1 is an external perspective view of a multi-function device 10 (also referred to as an ink jet recording apparatus) according to an aspect of the invention.

The multi-function device (MFD) 10 having integrally a printer part 11 in a lower part and a scanner part 12 in an upper part, and has a printer function and a scanner function and a copier function. Of the multi-function device 10, the printer part 11 is an ink jet recording apparatus according to one or more aspects of the invention. The functions other than the printer function may be dispensed with. Accordingly, aspects of the invention can also be applied to a single-function printer not having a scanner function or a copier function, which the scanner part 12 is omitted, and can be applied to a unit having a facsimile function with a communication part.

When aspects of the invention is an ink jet recording apparatus of a multi-function device, it may be constructed as a small unit like the multi-function device 10 of this embodiment or may be constructed as a large unit having multiple paper-feed cassettes and automatic document feeders (ADF). And, the multi-function device 10 may be constructed to be connected mainly to a computer (not shown) and to record images and text on recording paper (a recording medium) on the basis of image data and text data sent to it from the computer. Also, the multi-function device 10 may be constructed to be connected to a digital camera and record image data outputted from the digital camera on recording paper, or to have any of various recording media loaded into it and record image data recorded on the recording media onto recording paper.

Although it will be discussed in more detail later, in at least one aspect, only a small number of different inks (basic color inks) may be pre-stored, and many different mixed inks are created inside the multi-function device 10. And because by this, many different inks are used in image formation, the color reproducibility of the multi-function device 10 is improved. Furthermore, because the number of pre-stocked basic inks is small, the running cost of the multi-function device 10 does not increase significantly.

As FIG. 1 shows, the multi-function device 10 may have the rough external shape of a wide, low rectangular parallelepiped, and the width dimension and the front-rear depth direction of the multi-function device 10 are set larger than the height dimension. Other shapes are possible. The printer part 11 is provided in a lower part of the multi-function device 10. The printer part 11 has an opening 13 in its front face. A paper feed tray 14 and a paper eject tray 15 are provided at two levels one above the other so as to be exposed in this opening 13. The paper feed tray 14 is for storing recording paper and is capable of receiving recording paper of various sizes such as B5 size and postcard size up to and including A4 size. The paper feed tray 14 has a slide tray 16, and the slide tray 16 can be pulled out as necessary to present a larger tray face. The recording paper received on the paper feed tray 14 is fed into the printer part 11 and has a predetermined image recorded upon it before being ejected onto the paper eject tray 15.

The scanner part 12 can be provided in an upper part of the multi-function device 10. This scanner part 12 can be constructed as a so-called flat bed scanner. The multi-function device 10 has a document cover 17. The document cover 17 is provided open/closably with respect to the multi-function device 10 and is constructed as a roof plate of the multi-function device 10. A platen glass and an image-reading cartridge (not shown) are mounted on the lower side of the document cover 17. The platen glass is for setting a document on. The image-reading cartridge is mounted below this platen glass and is slidable in a main scanning direction (the width direction of the multi-function device 10). The image-reading cartridge reads the document by sliding in the width direction of the multi-function device 10.

An operating panel 18 is provided on an upper part of the front face of the multi-function device 10. This operating panel 18 is a device for operating the printer part 11 and the scanner part 12. The operating panel 18 is made up of various operating buttons and a liquid crystal display. The multi-function device 10 operates in accordance with operating instructions from this operating panel 18 or in accordance with instructions sent to it from a computer via a printer driver. And, a slot 19 is provided in an upper left part of the front face of the multi-function device 10. Any of various small memory cards, which are recording media, can be loaded into this slot 19. Image data recorded on the small memory card is displayed on the liquid crystal display. And by the operating panel 18 being operated, any image recorded on the small memory card can be recorded on recording paper by the printer part 11.

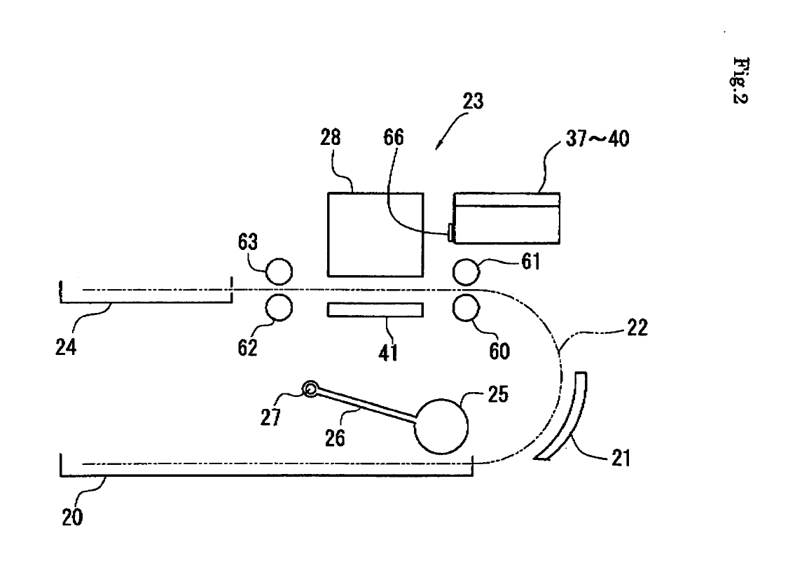

FIG. 2 is a schematic view showing the construction of a printer part 11 of the multi-function device 10. In this figure, the direction perpendicular to the paper is the width direction and the above-mentioned main scanning direction of the multi-function device 10.

A paper feed tray 20 is provided at the bottom of the multi-function device 10. An inclined separating plate 21 for separating recording paper loaded on the paper feed tray 20 and guiding it upward is disposed on the rear side of this paper feed tray 20 (the right side in the figure). A feed path 22 is formed oriented upward from this inclined separating plate 21. And, after extending upward, this feed path 22 curves toward the left and extends from the back face side of the multi-function device 10 to the front face side. The feed path 22 passes through the image-recording part 23 to the paper eject tray 24. Accordingly, recording paper received in the paper feed tray 20 is guided by the feed path 22 so as to make a U-turn while moving upward and reach an image-recording part 23. After the image-recording part 23 has carried out image-recording on the recording paper, this recording paper is ejected onto a paper eject tray 24.

A paper feed roller 25 is mounted above the paper feed tray 20. The paper feed roller 25 separates recording paper loaded on the paper feed tray 20 one sheet at a time and feeds it to the feed path 22. The construction of the paper feed roller 25 is a known one, and for example the paper feed roller 25 is rotatably mounted on the distal end of an upward/downwardly pivoting paper feed arm 26 so that it can move in and out of contact with the paper feed tray 20. This paper feed roller 25 is connected to a motor by way of a drive transmission mechanism. This drive transmission mechanism can be made up of a number of meshing gears. When the motor operates, its driving force is transmitted to the paper feed roller 25 and the paper feed roller 25 rotates.

The paper feed arm 26 is mounted pivotally about a base end shaft 27. As a result, the paper feed arm 26 can swing up and down about the base end shaft 27 as a center of swing. In a standby state the paper feed arm 26 is held in a raised position by a paper feed clutch and a spring (not shown), and to feed recording paper it swings down to a lowered position. When the paper feed arm 26 swings down to its lowered position, the paper feed roller 25 mounted on its distal end makes pressing contact with the surface of the recording paper on the paper feed tray 20. In that state, the paper feed roller 25 rotates. A frictional force between the roller surface of the paper feed roller 25 and the recording paper feeds the uppermost sheet of recording paper out to the inclined separating plate 21. The leading end of this recording paper hits the inclined separating plate 21 and the recording paper is guided upward and fed into the feed path 22. As the uppermost sheet of recording paper is fed out by the by the paper feed roller 25, it sometimes happens that by the action of friction or static electricity the sheet of recording paper directly below it is also fed out. However, this recording paper is stopped by hitting the inclined separating plate 21.

Parts of the feed path 22 other than where the image-recording part 23 is disposed are formed by an outer guide surface and an inner guide surface that face each other with a predetermined spacing. In this multi-function device 10, the outer guide surface is constituted by an inner wall surface of a frame of the multi-function device 10, and the inner guide surface is constituted by the surface of a guide member mounted inside the frame of the multi-function device 10. And, particularly where the feed path 22 curves, carrying rollers may be provided. Although no carrying rollers are shown in FIG. 2, carrying rollers may be rotatably mounted with the width direction of the feed path 22 (the direction perpendicular to the paper in the figure) as the direction of the center axis of rotation of each. The carrying rollers are mounted so that their roller faces are exposed at the outer guide surface or the inner guide surface. By carrying rollers being provided like this, the recording paper can be carried smoothly in contact with the guide surfaces even where the feed path 22 is curved.

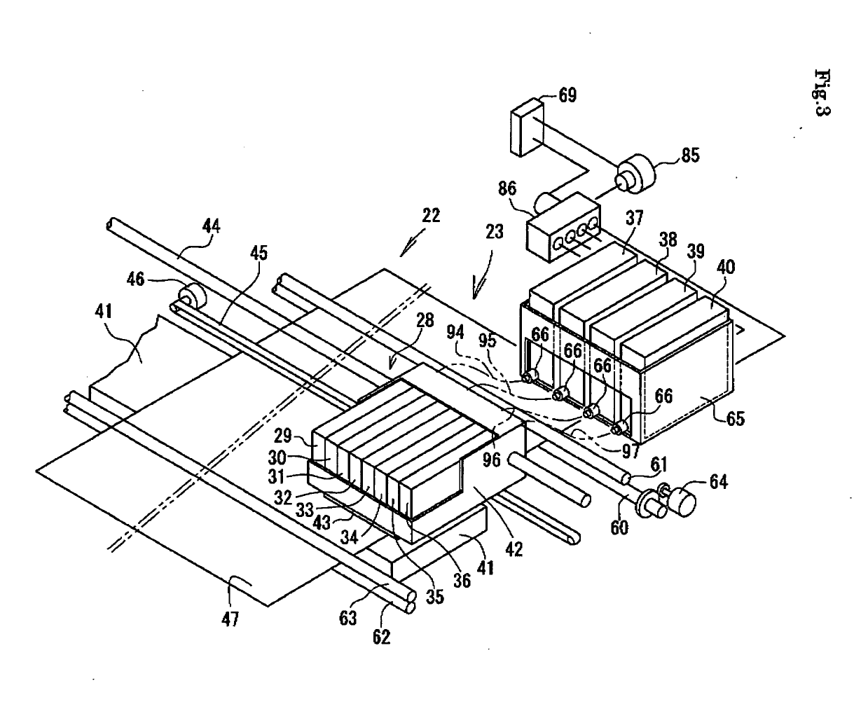

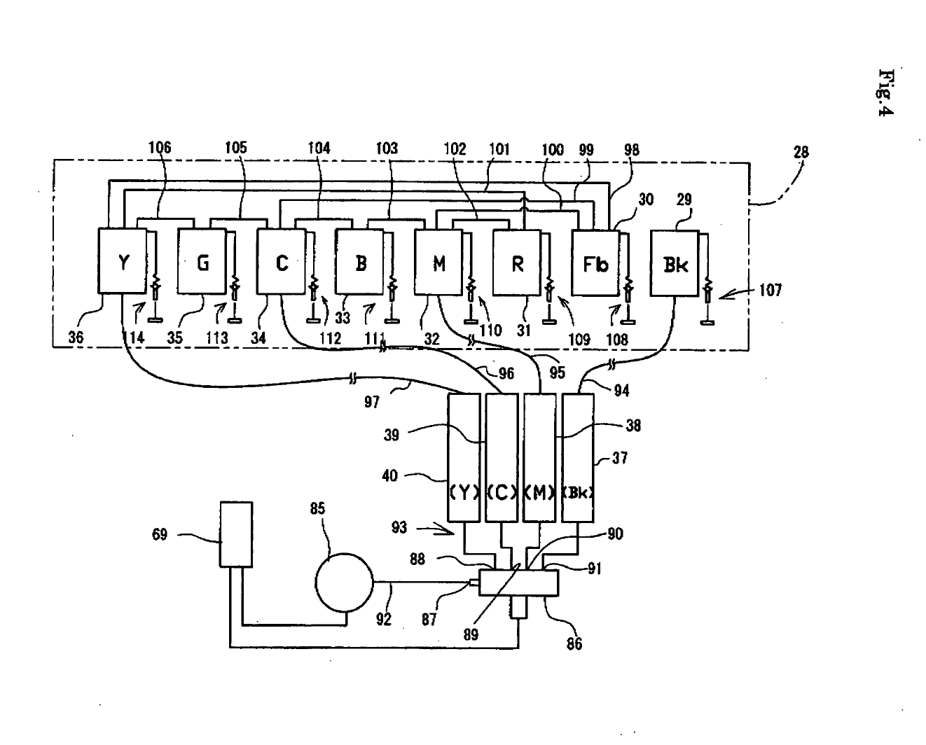

The image-recording part 23 is mounted on the downstream side, after the feed path 22 has made its upward U-turn. FIG. 3 is a perspective view showing the construction of the image-recording part 23 schematically, and FIG. 4 is a block diagram showing the construction of the image-recording part 23 schematically.

As shown in FIG. 2 through FIG. 4, the image-recording part 23 has a head part 28; a platen 41 disposed facing the head part 28; sub-tanks 29 to 36 for supplying ink to a recording head 43 (ink jet recording head), which will be further discussed later; cartridge-type ink tanks 37 to 40 for supplying ink to these sub-tanks 29 to 36; a pressurizing pump 85 for pressurizing the ink tanks 37 to 40; an electromagnetic switching valve 86 disposed between the pressurizing pump 85 and the ink tanks 37 to 40; and a control unit 69 for controlling the electromagnetic switching valve 86 and the pressurizing pump 85 and so on.

The ink tanks 37 to 40 do not have to be of cartridge type, and can be any tanks that store ink. The image-recording part 23 is for recording an image on a sheet of recording paper 47 being carried over the platen 41. That is, an image is recorded on the recording paper 47 by the head part 28 being made to slide in the main scanning direction while discharging different colors of ink such as black (Bk), magenta (M), cyan (C), and yellow (Y) supplied to it from the ink tanks 37 to 40.

The pressurizing pump 85 is of a known construction and is connected to all the ink tanks 37 to 40 in parallel by way of the electromagnetic switching valve 86. The electromagnetic switching valve 86 has an input port 87 (see FIG. 4) and multiple output ports 88 to 91. In this embodiment, because four ink tanks 37 to 40 are provided, the same number of output ports 88 to 91 may be provided. The pressurizing pump 85 is connected to the input port 87, and a fixed pressure (ink supply pressure) generated by the pressurizing pump 85 is inputted to the input port 87. The pressurizing pump 85 and the electromagnetic switching valve 86 are connected by a connecting pipe 92 consisting of a fixed pipe or a flexible tube or the like. By the electromagnetic switching valve 86 operating, the ink supply pressure inputted to the input port 87 can be distributed to any of the output ports 88 to 91.

The distribution of the ink supply pressure through electromagnetic switching valve 86 may include supplying pressure to only one of the output ports 88 to 91 at a time. An advantage is the consistent supply of pressure to the individual output ports 88 to 91. Alternatively, distribution of the ink supply pressure through electromagnetic switching valve 86 may include supplying pressure to two or more of the output ports 88 to 91 at a time. Further, the electromagnetic switching valve 86 may supply pressure to all output ports 88 to 91 with the regulation of ink flow into or between sub-tanks controlled by operation of one or more valves open/closed switch valves 107 to 114.

The electromagnetic switching valve 86 may supply pressure to the output ports 88 to 91, independently or as dependent on each other. Here, for instance, pressure may be applied to a first output port while a second output port and a third output port independently pressurized and not pressurized. Alternatively, pressure may be applied to a first port then pressure stopped while other ports are set to receive pressure before pump 85 supplying pressure again.

The output ports 88 to 91 are connected to the ink tanks 37 to 40 respectively. The output ports 88 to 91 and the ink tanks 37 to 40 are connected by connecting pipes 93 consisting of fixed pipes or flexible tubes or the like. By the pressurizing pump 85 and the electromagnetic switching valve 86 operating, the ink supply pressure is applied to certain of the ink tanks 37 to 40. As will be further discussed later, the operation of the pressurizing pump 85 and the operation of the electromagnetic switching valve 86 are controlled by the control unit 69.

And, connecting pipes 94 to 97 consisting of pliable tubes are connected to the ink tanks 37 to 40 respectively. As will be further discussed later, the head part 28 is slidable in the left-right direction in FIG. 4. As well as being pliable, the connecting pipes 94 to 97 are set to an ample length. Because of this, the connecting pipes 94 to 97 can deform so as to follow the sliding of the head part 28 smoothly.

As shown in FIG. 3, the head part 28 has a scanning carriage 42. The sub-tanks 29 to 36 are held in this scanning carriage 42. The head part 28 includes the above-mentioned recording head 43, and this recording head 43 is also held on the scanning carriage 42. The recording head 43 is disposed so as to be exposed on the underside of the scanning carriage 42, and ink is supplied to the recording head 43 from the sub-tanks 29 to 36. The scanning carriage 42 is supported on a guide shaft 44 and can be made to slide along this guide shaft 44. An endless belt 45 is attached to the scanning carriage 42. A belt drive motor 46 is connected via a pulley to this endless belt 45, and when the belt drive motor 46 operates it slides the head part 28 in the main scanning direction.

FIG. 4 shows four basic color inks {cyan, magenta, yellow, black} and four mixed color inks {green, blue, red, photo black}. The inks may be made of pigments and/dyes. For instance, cyan, magenta, and yellow may be made of dyes while black is made of one or more pigments. Accordingly, green, blue, red, and photo black may be made of dyes from the basic colors. The result is 4 basic colors and 4 mixed colors (for instance, n=4 and m=4 where n is the number of basic color inks and m is the number of mixed color inks).

Alternatively, the inks may be all of the same type of base material (dye-based or pigment-based). In this alternate aspect, the number of total inks (or ink tanks) in the head part 28 may be kept the same or modified reduced. For instance, in a first example, four basic color inks may be used (Y, C, M, Bk) which are mixed to form three mixed colors (R, G, B). Here, the photo black color ink and associated ink sub-tank have been eliminated. In other words, n=4 and m=3. In a second example, only three basic color inks may be used (Y, C, M) which are mixed to form four mixed colors (R, G, B, Fb). Here, the Bk ink and associated Bk ink tank have been eliminated. In other words, n=3 and m=4.

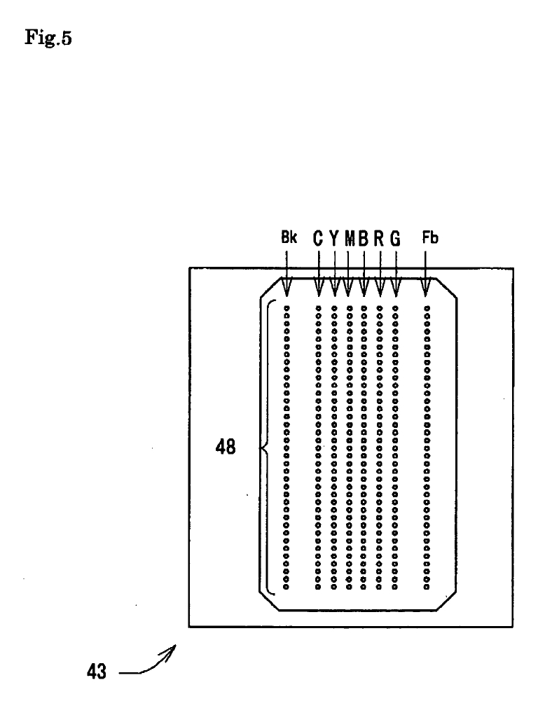

FIG. 5 is an enlarged bottom view of the recording head 43, and shows the construction of the underside of the recording head 43 in detail.

As shown in the figure, ink discharge openings 48 are arrayed in vertical lines on the underside of the recording head 43. The vertical direction in this figure is the carrying direction of the recording paper 47. In this embodiment, 8 rows of ink discharge openings 48 are provided. The ink discharge openings 48 positioned farthest to the left side in the figure correspond to black ink (Bk), and black ink (Bk ink) is discharged from these ink discharge openings 48. Neighboring these ink discharge openings 48 for Bk ink in turn, 7 further rows of ink discharge openings 48 are provided. These rows of ink discharge openings 48 respectively correspond to cyan ink (C), yellow ink (Y), magenta ink (M), blue ink (B), red ink (R), green ink (G) and photo black ink (Fb), and from these ink discharge openings 48 cyan ink (C ink), yellow ink (Y ink), magenta ink (M ink), blue ink (B ink), red ink (R ink), green ink (G ink) and photo black ink (Fb ink) are discharged. That is, this recording head 43 can discharge 8 colors of ink.

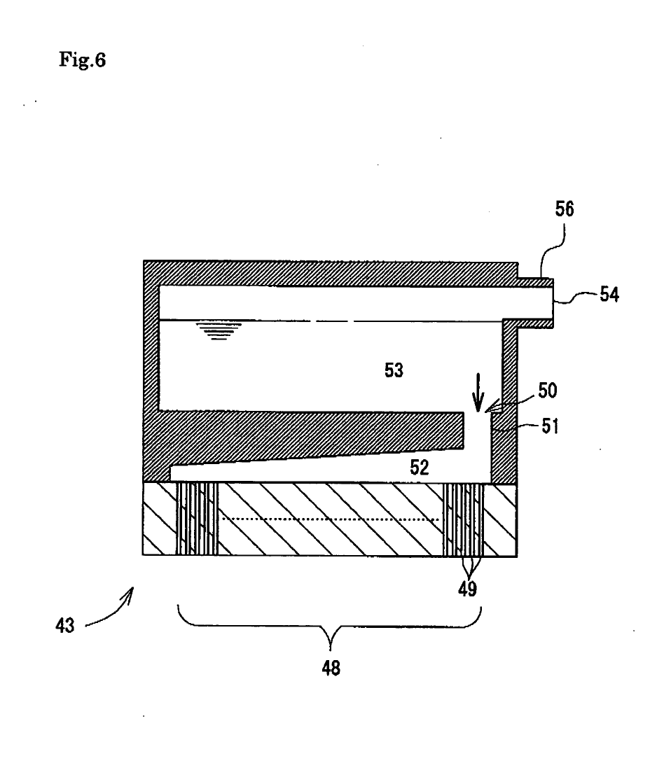

FIG. 6 is a sectional view of the head part 28.

As shown in this figure, multiple nozzles 49 constituting the ink discharge openings 48 are lined up in the bottom of the recording head 43 for each of the colors of ink Bk, C, Y, M, B, R, G, Fb. For the nozzles 49 corresponding to each color of ink, a manifold 50 is formed on the upstream side of the nozzles 49. The manifold 50 is made up of a supply pipe 51 formed at one end of the nozzles 49 and a manifold chamber 52 formed continuously to the nozzles 49, and ink supplied through the supply pipe 51 is distributed to the nozzles 49 through the manifold chamber 52.

A face of the manifold chamber 52 opposite the nozzles 49 is sloping so as to tilt downstream in the direction in which the ink flows, and the cross-sectional area of the manifold chamber 52 gradually becomes smaller with progress downstream. As the mechanism for discharging ink droplets through the ink discharge openings 48, any of various known mechanisms can be employed, and in this embodiment a mechanism for propelling ink droplets by means of deformation of a piezoelectric material is employed.

A buffer tank 53 is disposed above the manifold 50. A buffer tank 53 is provided for each color of ink, like the nozzles 49 and the manifold 50. These buffer tanks 53 may constitute one or all of the above-mentioned sub-tanks 29 to 36. Ink inside the ink tanks 37 to 40 is supplied to the sub-tanks 29 to 36 through ink supply openings 54. In this way, without ink being supplied from the ink tanks 37 to 40 to the nozzles 49 directly, by ink being temporarily stocked in the buffer tanks 53 (sub-tanks 29 to 36), air bubbles arising in the ink are removed and air bubbles are prevented from entering the manifold 50. And, air bubbles caught in the buffer tanks 53 (sub-tanks 29 to 36) are removed through air bubble exhaust openings (not shown).

Of the sub-tanks 29 to 36 (buffer tanks 53) corresponding to the color inks (Bk, C, Y, M, B, R, G, Fb), the sub-tanks corresponding to Bk ink, M ink, C ink and Y ink each have a mating part 56. The ink supply openings 54 are provided in these mating parts 56. Although it is not shown clearly in FIG. 6, the connecting pipes 94 to 97 consisting of pliable tubes are connected to these mating parts 56. Thus, as shown in FIG. 4, the ink tank 37 and the sub-tank 29 are connected by the connecting pipe 94, the ink tank 38 and the sub-tank 32 are connected by the connecting pipe 95, the ink tank 39 and the sub-tank 34 are connected by the connecting pipe 96, and the ink tank 40 and the sub-tank 36 are connected by the connecting pipe 97.

As shown in FIG. 4, the sub-tanks 30 to 36 are connected to each other by connecting pipes 98 to 106 (ink distribution pipes). These connecting pipes 98 to 106 may be fixed pipes, and in that case the connecting pipes 98 to 106 may be formed in the scanning carriage 42. The connecting pipe 98 connects the sub-tank 30 and the sub-tank 36. The connecting pipe 99 connects the sub-tank 30 and the sub-tank 34. The connecting pipe 100 connects the sub-tank 30 and the sub-tank 32. The connecting pipe 101 connects the sub-tank 31 and the sub-tank 36. The connecting pipe 102 connects the sub-tank 31 and the sub-tank 32. The connecting pipe 103 connects the sub-tank 32 and the sub-tank 33. The connecting pipe 104 connects the sub-tank 33 and the sub-tank 34. The connecting pipe 105 connects the sub-tank 34 and the sub-tank 35. And the connecting pipe 106 connects the sub-tank 35 and the sub-tank 36.

The sub-tanks 29 to 36 respectively have open/closed switch valves 107 to 114 (opening and closing valves). The open/closed switch valves 107 to 114 are for releasing pressure (back pressure) built up inside the sub-tanks 29 to 36. The open/closed switch valves 107 to 114 can each be constituted as for example a type of non-return valve. The open/closed switch valves 107 to 114 have operating members, and the open/closed switch valves 107 to 114 open when these operating members operate. The operation of these operating members is controlled by the control unit 69.

As mentioned above, the sub-tanks 29 to 36 (buffer tanks 53) are connected to the manifold chambers 52 through the supply pipes 51 (see FIG. 6). Accordingly, colors of ink supplied from the ink tanks 37 to 40 flow through the sub-tanks 29 to 36 (buffer tanks 53) and the manifolds 50 to the nozzles 49. The recording head 43 discharges the colors of ink through the ink discharge openings 48 as ink droplets. The means by which the colors of ink (Bk, C, Y, M, B, R, G, Fb) are supplied to the sub-tanks 29 to 36 will be explained in detail later.

As shown in FIG. 2 and FIG. 3, a drive roller 60 and a pressing roller 61 are provided in the upstream side of the image-recording part 23. The drive roller 60 and the pressing roller 61 sandwich the recording paper 47 being carried along the feed path 22 and feed it over the platen 41. Also, an eject roller 62 and a pressing roller 63 are provided in the downstream side of the image-recording part 23. The eject roller 62 and the pressing roller 63 sandwich and feed the recording paper 47 having been recorded upon. The drive roller 60 is rotationally driven by a motor 64, and the eject roller 62 is also rotationally driven by a similar motor. By this means the recording paper 47 is fed intermittently through a predetermined line width.

The pressing roller 61 is urged against the drive roller 60 so as to press the drive roller 60 with a predetermined pressing force. Accordingly, when the recording paper 47 has come between the drive roller 60 and the pressing roller 61, the pressing roller 61 retreats elastically by an amount corresponding to the thickness of the recording paper 47 as it cooperates with the drive roller 60 to sandwich the recording paper 47. Because of this, the rotational force of the drive roller 60 is transmitted to the recording paper 47 with certainty. The pressing roller 63 is mounted in the same way with respect to the eject roller 62. However, because the pressing roller 63 presses upon a sheet of recording paper 47 that has been recorded upon, its roller face is preferably formed in a spur shape so that it does not degrade the recorded image.

The recording paper 47 sandwiched between the drive roller 60 and the pressing roller 61 is carried intermittently over the platen 41 through the predetermined line width. The recording head 43 is made to slide for every line of the recording paper 47, and performs image-recording from the leading end of the recording paper 47. The recording paper 47 on which image-recording has been carried out is sandwiched between the eject roller 62 and the pressing roller 63, from its leading end. In other words, the recording paper 47 is carried intermittently through the predetermined line width with its leading end sandwiched between the eject roller 62 and the pressing roller 63 and its trailing end sandwiched between the drive roller 60 and the pressing roller 61, and the recording head 43 records an image on the recording paper 47. As the recording paper 47 is carried further, the trailing end of the recording paper 47 emerges from between the drive roller 60 and the pressing roller 61. Consequently, the recording paper 47 is released from the drive roller 60 and the pressing roller 61 and is carried intermittently through the predetermined line width by the eject roller 62 and the pressing roller 63. In this case also, the recording head 43 performs recording of an image onto the recording paper 47. After an image has been recorded in a predetermined area of the recording paper 47, the eject roller 62 is rotationally driven continuously and the recording paper 47 sandwiched between the eject roller 62 and the pressing roller 63 is ejected onto the paper eject tray 24.

As shown in FIG. 3, the ink tanks 37 to 40 are held in a holder 65. As mentioned above, the ink tanks 37 to 40 respectively hold Bk ink, M ink, C ink and Y ink. Here, the Bk ink, M ink, C ink and Y ink are defined as ‘basic color inks’. On a lower part of each of the ink tanks 37 to 40, a connecting part 66 to be connected to the mating part 56 of one of the sub-tanks 29 to 36 is provided. The connecting pipes 94 to 97 are connected to these connecting parts 66.

By multiple basic color inks being supplied to any one of the sub-tanks 30, 31, 33 and 35, a mixed ink is created. In this embodiment, as mentioned above, Bk ink is supplied to the sub-tank 29, M ink to the sub-tank 32, C ink to the sub-tank 34, and Y ink to the sub-tank 36. That is, the sub-tanks 29, 32, 34 and 36 hold basic color inks. Because of this, these sub-tanks 29, 32, 34 and 36 are called basic color sub-tanks.

The sub-tanks 30, 31, 33, 35, in order, hold Fb ink, R ink, B ink and G ink. The B ink is made by mixing C ink and M ink; the R ink is made by mixing Y ink and M ink; the G ink is made by mixing Y ink and C ink. The Fb ink is made by mixing Y ink and M ink and C ink. That is, the B ink, the R ink, the G ink and the Fb ink are mixed color inks made by mixing basic color inks. Because of this, the sub-tanks 30, 31, 33, 35 are called mixed color ink sub-tanks.

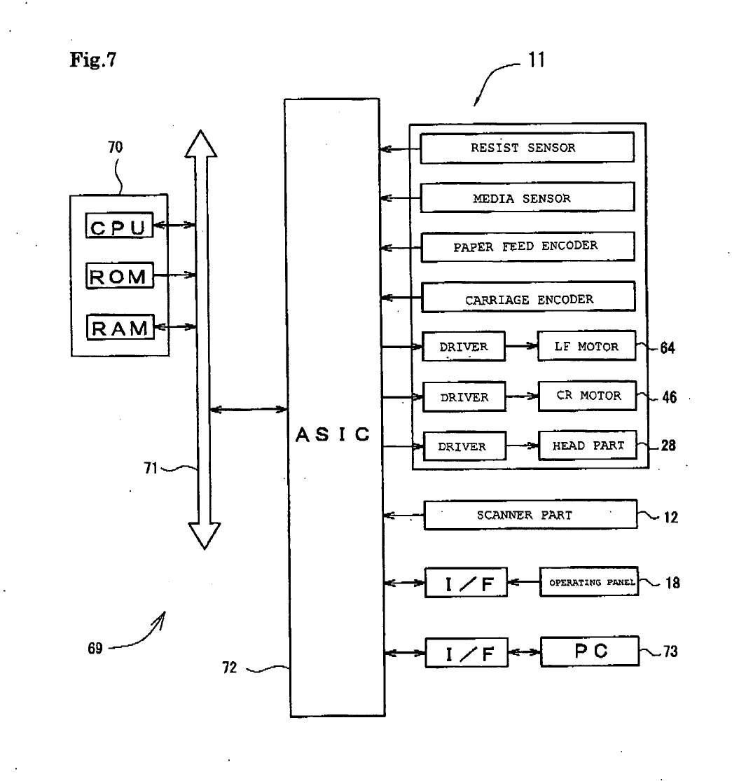

FIG. 7 is a block diagram showing the construction of a control unit 69 of the multi-function device 10.

As the figure shows, the control unit 69 has a central processing part 70 having a CPU (Central Processing Unit), ROM (Read-Only Memory), and RAM (Random Access Memory), and this central processing part 70 is connected to various sensors, the printer part 11, the scanner part 12 and the operating panel 18 and so on by a bus 71 and an ASIC (Application-Specific Integrated Circuit) 72 so that data can be exchanged between them.

The ROM of the central processing part 70 stores a predetermined computer program. The CPU, in accordance with this computer program, performs computation on the basis of information from the various sensors. By this means, besides rotation control of the motor 64 (LF motor) constituting the drive source of the drive roller 60 and rotation control of the belt drive motor 46 (CR motor) for sliding the head part 28, operation control of the pressurizing pump 85 for pressurizing the ink tanks 37 to 40 and switching control of the electromagnetic switching valve 86, and opening/closing control of the open/closed switch valves 107 to 114 provided on the sub-tanks 29 to 36, are carried out centrally.

Besides its inputs from the operating panel 18, the multi-function device 10 can be connected to for example a personal computer (PC) 73 and record images and text on the recording paper 47 on the basis of image data and text data sent to it from this computer 73. For this purpose it is also provided with an interface (I/F) for exchanging data with the computer 73. The construction of the control unit 69 shown in this embodiment is just an example, and a control unit of any construction that will perform the control described in the following can of course be employed.

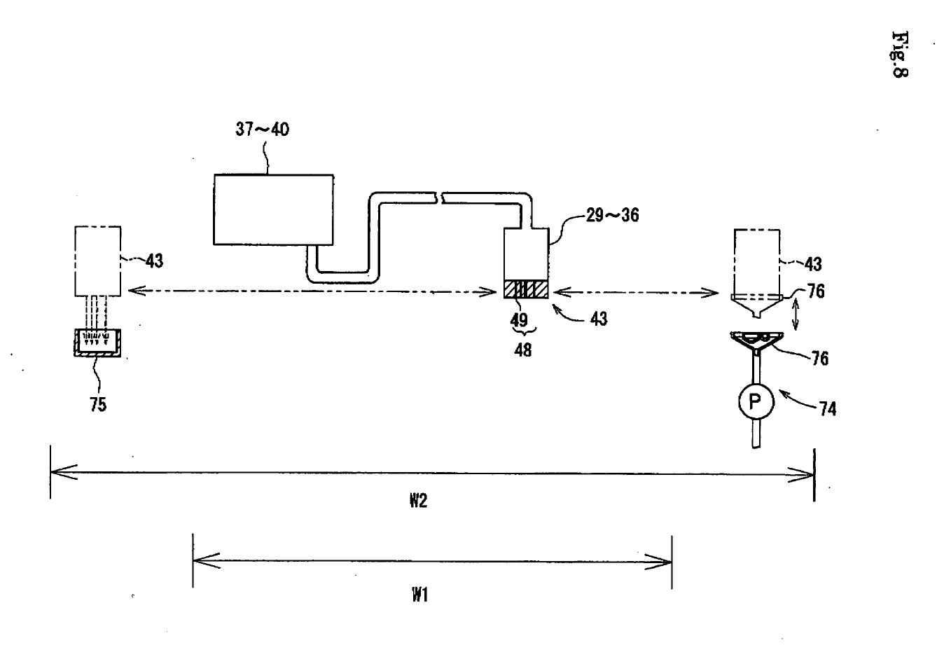

FIG. 8 shows schematically the supply path of ink from the ink tanks 37 to 40 to the recording head 43 via the sub-tanks 29 to 36 and the operating positions of the recording head 43.

Ink supplied from the ink tanks 37 to 40 is stored in the sub-tanks 29 to 36 (buffer tanks 53; see FIG. 6), where air bubbles in the ink are caught as mentioned above. This ink flows through the supply pipe 51 (see FIG. 6) into the manifold chamber 52 and is distributed among the nozzles 49 and discharged through the nozzles 49 as ink droplets. By the recording head 43 discharging ink droplets of the different colors of ink like this while sliding over an image recording range W1, an image is recorded on the recording paper 47 being carried below the recording head 43.

And, as shown in FIG. 8, a purge mechanism 74 and a waste ink tray 75 are disposed at opposite ends of a scannable range W2, outside the image-recording range W1 of the recording head 43. The purge mechanism 74 is for removing air bubbles and foreign matter from the nozzles 49 of the recording head 43 by suction. When the recording head 43 slides to the right end of the scannable range W2, a cap 76 of the purge mechanism 74 moves upward and the cap 76 makes contact with the underside of the recording head 43 so as to cover the ink discharge openings 48. A suction pump is connected to this cap 76. By this suction pump operating, ink is sucked through the nozzles 49 of the recording head 43. Control of the belt drive motor 46 for sliding the recording head 43, movement control of the cap 76, and control of the suction pump are carried out by the control unit 69.

The waste ink tray 75 is for receiving preparatory discharge of ink from the recording head 43. This kind of preparatory discharge of ink is generally called flashing. At the time of flashing, the recording head 43 is moved to the left end of the scannable range W2. In that position, the different colors of ink are discharged into the waste ink tray 75 in preparation for printing. The left-right dispositions of the purge mechanism 74 and the waste ink tray 75 are not particularly limited, and alternatively they may be disposed left-right oppositely to that described above or may both be disposed on either the left or the right.

The holder 65 (see FIG. 3) holding the ink tanks 37 to 40 can be mounted for example at the right end of the scannable range W2. However, this holder 65 may of course be installed at the left end of the scannable range W2 or in some other dead space in the frame of the multi-function device 10. The basic color inks stored in the ink tanks 37 to 40 (Bk ink, C ink, Y ink, M ink) are transferred to the sub-tanks 29 to 36 as follows.

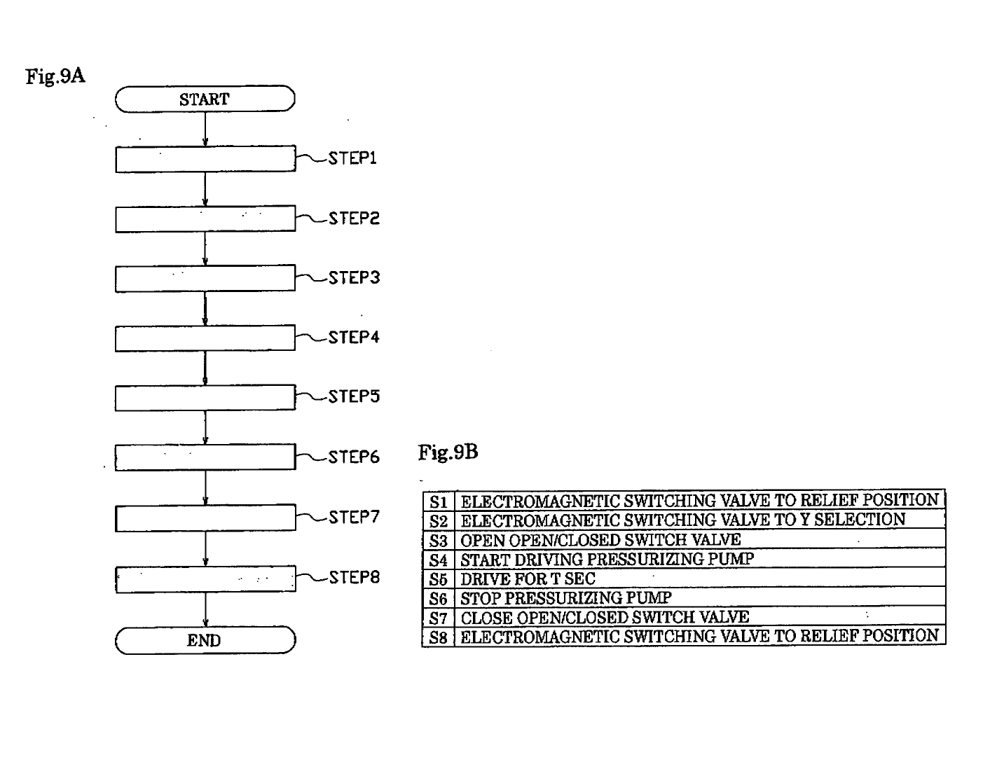

FIG. 9A through FIG. 11B are flow charts showing how basic color inks are supplied from the ink tanks 37 to 40 into the sub-tanks 29 to 36.

FIGS. 9A and 9B show how Y ink among the basic color inks is supplied into the basic color sub-tank 36. As this figure and FIG. 4 show, normally the electromagnetic switching valve 86 is in a relief position (STEP 1). In this case, even if the pressurizing pump 85 were to operate, the ink supply pressure would be released to the atmosphere. Next, the electromagnetic switching valve 86 is switched to a Y selection position (STEP 2). As a result of this, when the pressurizing pump 85 operates, an ink supply pressure is applied to the ink tank 40. Then, the open/closed switch valve 114 is operated (STEP 3). By this means, the pressure inside the basic color sub-tank 36 is released to the atmosphere. Next, the pressurizing pump 85 is operated for a fixed time (Tsec), and then stopped (STEP 4 to STEP 6). By this means, an ink supply pressure is applied to the ink tank 40 via the electromagnetic switching valve 86 and a predetermined amount of Y ink is pushed out from the ink tank 40. This Y ink is fed via the connecting pipe 97 to the basic color sub-tank 36. As a result, a pressure arises inside the basic color sub-tank 36, but by the open/closed switch valve 114 operating, this pressure is released to the atmosphere. Therefore, Y ink flows smoothly into the basic color sub-tank 36. After that, the open/closed switch valve 114 is closed (STEP 7) and the electromagnetic switching valve 86 returns to its relief position (STEP 8). Because the open/closed switch valves 107 to 114 each constitute a type of non-return valve, as mentioned above, all of the open/closed switch valves 107 to 114 are normally closed. Therefore, if the open/closed switch valve 114 is closed, even if the pressure inside the ink tank 40 were to rise, all that would happen is that the pressure inside the basic color sub-tank 36 would rise (a pressure would arise), and inflow of Y ink to the basic color sub-tank 36 would not be allowed. In the same way, C ink is supplied from the ink tank 39 into the basic color sub-tank 34, and M ink is supplied from the ink tank 38 into the basic color sub-tank 32. And Bk ink is supplied from the ink tank 37 into the basic color sub-tank 29.

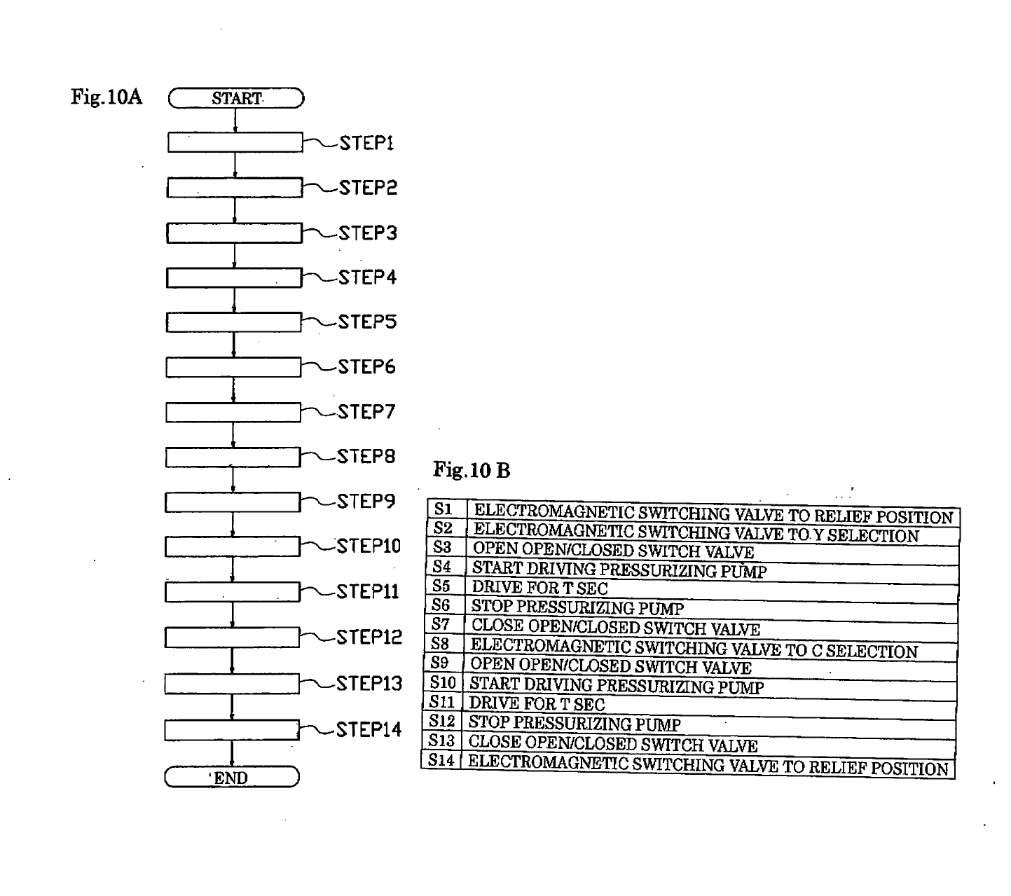

FIGS. 10A-10B show how G ink, which is a mixed color ink, is created by the basic inks Y ink and C ink being mixed. As this figure and FIG. 4 show, the electromagnetic switching valve 86 is normally in a relief position (STEP 1). In this case, even if the pressurizing pump 85 were to operate, the ink supply pressure would be released to the atmosphere. Next, the electromagnetic switching valve 86 is switched to the Y selection position (STEP 2). As a result of this, when the pressurizing pump 85 operates, an ink supply pressure is applied to the ink tank 40. Then, the open/closed switch valve 113 is operated (STEP 3). By this means, the pressure inside the mixed color sub-tank 35 is released to the atmosphere. Next, the pressurizing pump 85 is operated for a fixed time (Tsec), and then stopped (STEP 4 to STEP 6). By this means, an ink supply pressure is applied to the ink tank 40 via the electromagnetic switching valve 86 and a predetermined amount of Y ink is pushed out from the ink tank 40. This Y ink is fed via the connecting pipe 97 to the basic color sub-tank 36. Here, because the connecting pipe 106 connects the basic color sub-tank 36 and the mixed color sub-tank 35, as a result of the Y ink being supplied to the basic color sub-tank 36, a pressure arises inside the mixed color sub-tank 35; but by the open/closed switch valve 114 operating, this pressure is released to the atmosphere. Therefore, Y ink in the basic color sub-tank 36 flows smoothly into the mixed color sub-tank 35. After that, the open/closed switch valve 113 is closed (STEP 7), and the flow of Y ink into the mixed color sub-tank 35 is limited. Because the open/closed switch valves 107 to 114 each constitute a type of non-return valve, as mentioned above, all of the open/closed switch valves 107 to 114 are normally closed. Therefore, if the open/closed switch valve 113 is closed, even if the pressure inside the ink tank 40 were to rise, all that would happen is that the pressure inside the mixed color sub-tank 35 would rise (a pressure would arise), and inflow of Y ink to the mixed color sub-tank 35 would not be allowed.

Next, the electromagnetic switching valve 86 is switched to a C selection position (STEP 8). By this means, when the pressurizing pump 85 operates, an ink supply pressure is applied to the ink tank 39. Then, the open/closed switch valve 113 is operated (STEP 9). This releases the pressure inside the mixed color sub-tank 35 to the atmosphere. Next, the pressurizing pump 85 is operated for a fixed time (Tsec), and then stopped (STEP 10 to STEP 12). By this means, an ink supply pressure is applied to the ink tank 39 via the electromagnetic switching valve 86 and a predetermined amount of C ink is pushed out from the ink tank 39. This C ink is fed via the connecting pipe 96 to the basic color sub-tank 34. Here, because the connecting pipe 105 connects the basic color sub-tank 34 and the mixed color sub-tank 35, as a result of the C ink being supplied to the basic color sub-tank 34, a pressure arises inside the mixed color sub-tank 35; but by the open/closed switch valve 113 operating, this pressure is released to the atmosphere. Therefore, C ink in the basic color sub-tank 34 flows smoothly into the mixed color sub-tank 35. After that, the open/closed switch valve 113 is closed (STEP 13), and the electromagnetic switching valve 86 returns to the relief position (STEP 14). By this means, G ink is created by mixing inside the mixed color sub-tank 35. Because as mentioned above the open/closed switch valves 107 to 114 each constitute a type of non-return valve, all of the open/closed switch valves 107 to 114 are normally closed. Therefore, if the open/closed switch valve 113 is closed, even if the pressure inside the ink tank 39 were to rise, all that would happen is that the pressure inside the mixed color sub-tank 35 would rise (a pressure would arise), and inflow of C ink to the mixed color sub-tank 35 would not be allowed.

In the same way, C ink is supplied from the basic color sub-tank 34 via the connecting pipe 104 into the mixed color sub-tank 33, and M ink is supplied from the basic color basic color sub-tank 32 via the connecting pipe 103 into the mixed color sub-tank 33. By this means, B ink is created inside the mixed color sub-tank 33. And, M ink is supplied from the basic color sub-tank 32 via the connecting pipe 102 to the mixed color sub-tank 31, and Y ink is supplied from the basic color sub-tank 36 via the connecting pipe 101 to the mixed color sub-tank 33. And by this means, R ink is created inside the mixed color sub-tank 31.

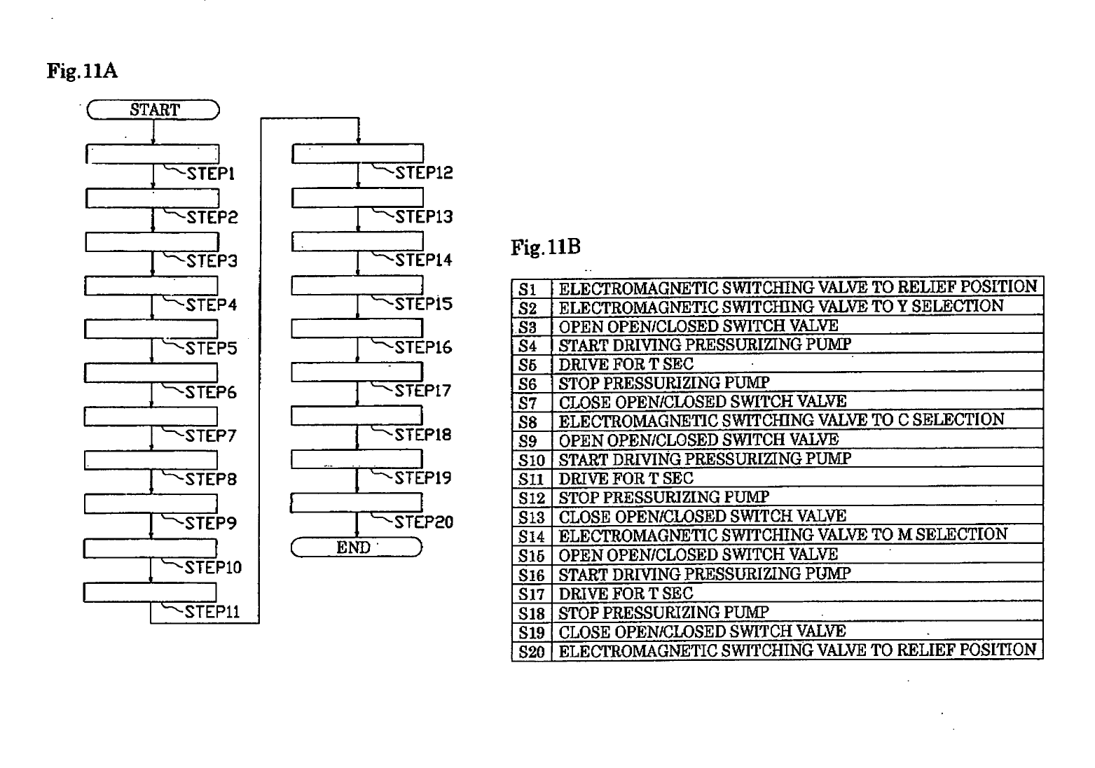

FIGS. 11A-11B show how Fb ink, which is a mixed color ink, is prepared by mixing the basic color inks Y ink, C ink and M ink. As this figure and FIG. 4 show, the electromagnetic switching valve 86 is normally in a relief position (STEP 1). In this case, even if the pressurizing pump 85 were to operate, the ink supply pressure would be released to the atmosphere. Next, the electromagnetic switching valve 86 is switched to the Y selection position (STEP 2). As a result of this, when the pressurizing pump 85 operates, an ink supply pressure is applied to the ink tank 40. Then, the open/closed switch valve 108 is operated (STEP 3). By this means, the pressure inside the mixed color sub-tank 30 is released to the atmosphere. Next, the pressurizing pump 85 is operated for a fixed time (Tsec), and then stopped (STEP 4 to STEP 6). By this means, an ink supply pressure is applied to the ink tank 40 via the electromagnetic switching valve 86 and a predetermined amount of Y ink is pushed out from the ink tank 40. This Y ink is fed via the connecting pipe 97 to the basic color sub-tank 36. Here, because the connecting pipe 98 connects the basic color sub-tank 36 and the mixed color sub-tank 30, as a result of the Y ink being supplied to the basic color sub-tank 36, a pressure arises inside the mixed color sub-tank 30; but by the open/closed switch valve 108 operating, this pressure is released to the atmosphere. Therefore, Y ink in the basic color sub-tank 36 flows smoothly into the mixed color sub-tank 30. After that, the open/closed switch valve 108 is closed (STEP 7), and the flow of Y ink into the mixed color sub-tank 35 is limited. Because the open/closed switch valves 107 to 114 each constitute a type of non-return valve, as mentioned above, all of the open/closed switch valves 107 to 114 are normally closed. Therefore, if the open/closed switch valve 108 is closed, even if the pressure inside the ink tank 40 were to rise, all that would happen is that the pressure inside the mixed color sub-tank 30 would rise (a pressure would arise), and inflow of Y ink to the mixed color sub-tank 35 would not be allowed.

Next, the electromagnetic switching valve 86 is switched to the C selection position (STEP 8). By this means, when the pressurizing pump 85 operates, an ink supply pressure is applied to the ink tank 39. Then, the open/closed switch valve 108 is operated (STEP 9). This releases the pressure inside the mixed color sub-tank 30 to the atmosphere. Next, the pressurizing pump 85 is operated for a fixed time (Tsec), and then stopped (STEP 10 to STEP 12). By this means, an ink supply pressure is applied to the ink tank 39 via the electromagnetic switching valve 86 and a predetermined amount of C ink is pushed out from the ink tank 39. This C ink is fed via the connecting pipe 96 to the basic color sub-tank 34. Here, because the connecting pipe 99 connects the basic color sub-tank 34 and the mixed color sub-tank 30, as a result of the C ink being supplied to the basic color sub-tank 34, a pressure arises inside the mixed color sub-tank 30; but by the open/closed switch valve 108 operating, this pressure is released to the atmosphere. Therefore, C ink in the basic color sub-tank 34 flows smoothly into the mixed color sub-tank 30. After that, the open/closed switch valve 108 is closed (STEP 13), and inflow of C ink to the mixed color sub-tank 35 is limited. Because as mentioned above the open/closed switch valves 107 to 114 each constitute a type of non-return valve, all of the open/closed switch valves 107 to 114 are normally closed. Therefore, if the open/closed switch valve 108 is closed, even if the pressure inside the ink tank 39 were to rise, all that would happen is that the pressure inside the mixed color sub-tank 30 would rise (a pressure would arise), and inflow of C ink to the mixed color sub-tank 30 would not be allowed.

Next, the electromagnetic switching valve 86 is switched to an M selection position (STEP 14). By this means, when the pressurizing pump 85 operates, an ink supply pressure is applied to the ink tank 38. Then, the open/closed switch valve 108 is operated (STEP 15). This releases the pressure inside the mixed color sub-tank 30 to the atmosphere. Next, the pressurizing pump 85 is operated for a fixed time (Tsec), and then stopped (STEP 16 to STEP 18). By this means, an ink supply pressure is applied to the ink tank 38 via the electromagnetic switching valve 86 and a predetermined amount of M ink is pushed out from the ink tank 38. This M ink is fed via the connecting pipe 95 to the basic color sub-tank 32. Here, because the connecting pipe 100 connects the basic color sub-tank 32 and the mixed color sub-tank 30, as a result of the M ink being supplied to the basic color sub-tank 32, a pressure arises inside the mixed color sub-tank 30; but by the open/closed switch valve 108 operating, this pressure is released to the atmosphere. Therefore, M ink in the basic color sub-tank 32 flows smoothly into the mixed color sub-tank 30. After that, the open/closed switch valve 108 is closed (STEP 19), and the electromagnetic switching valve 86 returns to its relief position (STEP 20). By this means, Fb ink is created by mixing in the mixed color sub-tank 30. Because as mentioned above the open/closed switch valves 107 to 114 each constitute a type of non-return valve, all of the open/closed switch valves 107 to 114 are normally closed. Therefore, if the open/closed switch valve 108 is closed, even if the pressure inside the ink tank 38 were to rise, all that would happen is that the pressure inside the mixed color sub-tank 30 would rise (a pressure would arise), and inflow of M ink to the mixed color sub-tank 30 would not be allowed.

In this way, the four basic color inks stored in the ink tanks 37 to 40 are respectively supplied as they are to the basic color sub-tanks 36, 34, 32 and 29, and by any two or more basic color inks being supplied to each of the mixed color sub-tanks 35, 33, 31 and 30, four types (four colors) of mixed color inks are created.

In a multi-function device 10 according to this embodiment, because four mixed color inks are created by mixing from four basic color inks, even though only four basic color inks are stored in the ink tanks 37 to 40 in advance, a total of eight types (eight colors) of ink are used for image formation. Therefore, the color reproducibility, which is a basic performance attribute of the multi-function device 10, is improved. And furthermore, because the number of basic color inks pre-stored is smaller than the number of inks used for image formation, the running cost of the multi-function device 10 does not increase greatly.

In this embodiment, as shown in FIG. 3, the ink tanks 37 to 40 are fixed to the frame of the multi-function device 10. During image-recording, i.e. when the scanning carriage 42 is being made to slide, the basic color sub-tanks 36, 34, 32 and 29 slide together with the recording head 43 and the basic color sub-tanks 36, 34, 32 and 29 move relative to the ink tanks 37 to 40. Because this relative movement of the basic color sub-tanks 36, 34, 32 and 29 is allowed by the connecting pipes 94 to 97, which are pliable tubes, the basic color inks are supplied to the basic color sub-tanks 36, 34, 32 and 29 well.

Because the connecting pipes 94 to 97 consist of pliable tubes, the mounting position of the ink tanks 37 to 40 is not subject to any particular limitation. Therefore, as mentioned above, the ink tanks 37 to 40 can be mounted for example in a dead space arising inside the frame. And, because the basic color inks are also supplied to the mixed color sub-tanks 35, 33, 31 and 30 as necessary (for example when the amount of ink remaining in the mixed color tank has become low), as well as the basic color sub-tanks 36, 34, 32 and 29, the capacities of the basic color sub-tanks 36, 34, 32 and 29 and the mixed color sub-tank 35, 33, 31 and 30 can be small. Therefore, the freedom of design of the vicinity of the recording head 43, including the scanning carriage 42, increases, and as a result it is possible to make the multi-function device 10 as a whole small and light.

And, in this multi-function device 10, because an electromagnetic switching valve 86 is used, as shown in FIG. 4, some or all of the ink tanks 37 to 40 can be pressurized simply and freely. Therefore, by the open/closed switch valves 107 to 114 operating, at the same time as the basic color inks are fed into the basic color sub-tanks 36, 34, 32 and 29 from the ink tanks 37 to 40 the basic color inks can be fed into the mixed color sub-tanks 35, 33, 31 and 30 and multiple mixed color inks can be created. As a result there is the advantage that when the amounts of ink remaining in the sub-tanks 29 to 36 have become low, ink can be resupplied quickly to any of the sub-tanks 29 to 36.

Also, in a multi-function device 10 according to this embodiment, open/closed switch valves 107 to 114 are provided on the sub-tanks 29 to 36, and furthermore the open/closed switch valves 107 to 114 consist of non-return valves of a simple construction. And, because by the open/closed switch valves 107 to 114 operating the inflow of inks to the sub-tanks 29 to 36 is allowed, there is the advantage that inflow and inflow restriction of ink to the sub-tanks 29 to 36 can be carried out surely and cheaply.

Although in this embodiment four basic color inks are pre-stocked, the number of basic color inks is not limited to this, and generally of course basic color inks of n colors may be stocked. In that case, the number of mixed color inks created by mixing the basic color inks is also not limited to four, and generally m types (m colors) of mixed color ink can be prepared.

What is claimed is:

1. An ink jet recording apparatus comprising:
n ink tanks for storing n basic color inks;
m mixed color sub-tanks each holding a mixed ink made by mixing at least two basic color inks;
pressurizing supply means for pressurizing the ink tanks; and
control means for controlling the pressurizing supply means so that at least two basic color inks are individually supplied to each of the mixed color sub-tanks.

2. The ink jet recording apparatus of claim 1, wherein the pressurizing supply means includes one or more ink distribution pipes, connected to the basic color tanks that distribute the basic color inks individually from the n basic color tanks to the m mixed color sub-tanks.

3. The ink jet recording apparatus of claim 1, further comprising:
one or more ink distribution pipes, connected to the basic color tanks that distribute the basic color inks individually from the n basic color tanks to the m mixed color sub-tanks, the basic color ink tanks having been pressurized by the pressurizing supply means.

4. The ink jet recording apparatus of claim 1, further comprising:
n basic color sub-tanks connected to the ink tanks, said n basic color tanks receiving said basic color inks.

5. The ink jet recording apparatus of claim 4, wherein said mixed color sub-tanks are filled with said basic color inks received from said basic color sub-tanks.

6. The ink jet recording apparatus of claim 1, further comprising:
opening/closing valves, one connected to each of the mixed color sub-tanks, that control the receipt of said basic color inks.

7. The ink jet recording apparatus according to claim 1,
wherein the mixed color sub-tanks are held in a scanning carriage together with an ink jet recording head.

8. The ink jet recording apparatus according to claim 7,
wherein the basic color sub-tanks are held in said scanning carriage, and
wherein the ink tanks are connected to the basic color sub-tanks by pliable tubes that allow relative movement of the basic color sub-tanks with respect to the ink tanks.

9. The ink jet recording apparatus according to claim 1, wherein
the pressurizing supply means comprises a pressurizing pump for creating an ink supply pressure to be applied to the ink tanks, and
a supply pressure switching unit, interposed between the pressurizing pump and the ink tanks, the supply pressure switching unit applying the ink supply pressure to at least one of the ink tanks.

10. The ink jet recording apparatus according to claim 9, wherein the supply pressure switching unit comprises a multi-way electromagnetic valve having an input port connected to the pressurizing pump and n output ports each connected individually to a respective one of the ink tanks.

11. The ink jet recording apparatus according to claim 6, wherein each of the opening/closing valves is an open/closed switch valve.

12. The ink jet recording apparatus according to claim 11,
wherein the opening of said open/close switch valve for said respective basic color sub-tank or mixed color sub-tank allows ink to flow from one of an ink tank into a first sub-tank or from said first sub-tank into a second sub-tank by releasing a pressure arising in the respective basic color sub-tank or mixed color sub-tank.

13. The ink jet recording apparatus according to claim 1, wherein m=n.

14. The ink jet recording apparatus according to claim 1, wherein m<n.

15. The ink jet recording apparatus according to claim 13, wherein m=n=4.

16. The ink jet recording apparatus according to claim 13, wherein m=n=3.

17. An ink jet recording apparatus comprising:
n ink tanks for storing n basic color inks;
m mixed color sub-tanks each holding a mixed ink made by mixing at least two basic color inks;
pressurizing supply pump that supplies a pressure, thereby pressurizing the ink tanks; and
control circuit that controls the pressurizing supply pump so that at least two basic color inks are individually supplied to each of the mixed color sub-tanks.

18. The ink jet recording apparatus of claim 17, further comprising:
one or more ink distribution pipes, connected to the basic color tanks that distribute the basic color inks individually from the n basic color tanks to the m mixed color sub-tanks, the basic color ink tanks having been pressurized by the pressurizing supply pump.

19. The ink jet recording apparatus of claim 17, further comprising:
opening/closing valves, one connected to each of the mixed color sub-tanks, that control the receipt of said basic color inks.

20. The ink jet recording apparatus according to claim 19,
wherein each of the opening/closing valves is an open/closed switch valve,
wherein the opening of said open/close switch valve for said respective basic color sub-tank or mixed color sub-tank allows ink to flow from one of an ink tank into a first sub-tank or from said first sub-tank into a second sub-tank by releasing pressure arising in the respective basic color sub-tank or mixed color sub-tank.

21. The ink jet recording apparatus according to claim 17, wherein
a supply pressure switching unit, interposed between the pressurizing pump and the ink tanks, the supply pressure switching unit applying the ink supply pressure to at least one of the ink tanks.

22. A method for mixing inks comprising the steps of:
applying pressure in a printer to one of a first ink tank or first ink sub-tank holding a first basic color ink;
applying pressure in said printer to one of a second ink tank or a second ink sub-tank holding a second basic color ink; and
receiving said first basic color ink and said second basic color ink in a first mixing sub-tank.

23. The method according to claim 22, further comprising the step of:
controlling an open/close valve associated with said first mixing sub-tank to release pressure in said first mixing sub-tank, thereby permitting at least one of said first basic color ink and said second basic color ink to flow into said first mixing sub-tank.

24. The method according to claim 22, wherein said first basic color ink flows into said first mixing sub-tank prior to said second basic color ink flowing into said first mixing sub-tank.

25. The method according to claim 22, wherein said first basic color ink and said second basic color ink flow into said first mixing sub-tank at the same time.
